(19) United States
(12) Patent Application Publication
(10) Pub. No.: US 2025/0297095 A1
(43) Pub. Date: Sep. 25, 2025

(54) POLYESTER COMPOSITION AND PRODUCT THEREOF

(71) Applicant: NAN YA PLASTICS CORPORATION, Taipei City (TW)

(72) Inventors: Ching-Yao Yuan, Taipei City (TW); Chun-Che Tsao, Taipei City (TW); Yueh-Shin Liu, Taipei City (TW); Ci Syuan Liou, Taipei City (TW)

(73) Assignee: NAN YA PLASTICS CORPORATION, Taipei City (TW)

(21) Appl. No.: 18/674,932

(22) Filed: May 27, 2024

(30) Foreign Application Priority Data
Mar. 20, 2024 (TW) 113110231

(51) Int. Cl. C08L 67/02; C08J 3/12; C08K 3/26; C08K 5/524

(52) U.S. Cl. CPC C08L 67/02; C08J 3/12; C08K 3/26; C08K 5/524; C08J 2367/02; C08J 2423/12; C08J 2477/02; C08K 2003/265; C08K 2201/005; C08L 2205/08

(57) ABSTRACT

A polyester composition and a product thereof are provided. The polyester composition includes a polyethylene terephthalate (A), an inorganic powder (B), a crystal nucleating agent (C), a lubricant (D) and an antioxidant (E).

### CROSS-REFERENCE TO RELATED APPLICATION

This application claims the priority benefit of Taiwan application serial no. 113110231, filed on Mar. 20, 2024. The entirety of the above-mentioned patent application is hereby incorporated by reference herein and made a part of this specification.

### BACKGROUND

### Technical Field

The invention relates to a polyester composition, and in particular to a polyester composition that can be processed under low temperature conditions and a product thereof.

### Description of Related Art

Polyethylene terephthalate (PET) has good tensile strength and flexural strength, and may be used in a wide range of applications, such as tableware, buckles, zippers, fabrics, etc. Recently, the common high-temperature-resistant polyethylene terephthalate material improves heat resistance by adding a glass fiber. However, the glass fiber-containing polyethylene terephthalate material has high hardness and brittleness, which makes it difficult to apply further process due to poor fluidity, resulting in poor processability.

### SUMMARY

The invention provides a polyester composition and a product thereof with good physical properties and processability.

A polyester composition of the invention includes polyethylene terephthalate (A), an inorganic powder (B), a crystal nucleating agent (C), a lubricant (D) and an antioxidant (E).

In an embodiment of the invention, the polyester composition does not include a glass fiber.

In an embodiment of the invention, the intrinsic viscosity (IV) of the polyethylene terephthalate (A) is 0.7 dL/g to 1 dL/g.

In an embodiment of the invention, the inorganic powder (B) includes talc powder, titanium dioxide, silicon dioxide, mica, calcium carbonate, calcium sulfate whisker or a combination thereof.

In an embodiment of the invention, the crystal nucleating agent (C) includes an organic acid sodium salt.

In an embodiment of the invention, the lubricant (D) includes a stearate, a polyethylene wax, a silicone modifier, a fluorine-based resin or a combination thereof.

In an embodiment of the invention, the antioxidant (E) includes a hindered phenolic-based antioxidant, a phenolic-based antioxidant, a phosphite ester-based antioxidant, a complex antioxidant or a combination thereof.

In an embodiment of the invention, the polyester composition further includes an other polymer (F), a compatibilizer (G) or a combination thereof. The other polymer (F) do not include the polyethylene terephthalate (A).

In an embodiment of the invention, the other polymer (F) include polypropylene (PP), nylon 6 (PA 6), nylon 66 (PA 66), nylon 12 (PA 12) or a combination thereof.

In an embodiment of the invention, the compatibilizer (G) includes ethylene-methyl acrylate-glycidyl methacrylate terpolymer (EMA-g-GMA), polyethylene octene grafted methacrylic acid glycidyl ester (POE-g-GMA), styrene-ethylene/butylene-styrene copolymer (SEBS), styrene-ethylene/butylene-styrene block copolymer grafted with maleic anhydride (SEBS-g-MAH) or a combination thereof.

In an embodiment of the invention, based on a total usage amount of the polyester composition being 100 parts by weight, a usage amount of the other polymer (F) is 2.5 parts by weight to 35 parts by weight, a usage amount of the compatibilizer (G) is 5 parts by weight to 20 parts by weight.

In an embodiment of the invention, based on a total usage amount of the polyester composition being 100 parts by weight, a usage amount of the polyethylene terephthalate (A) is 30 parts by weight to 80 parts by weight, a usage amount of the inorganic powder (B) is 5 parts by weight to 30 parts by weight, a usage amount of the crystal nucleating agent (C) is 0.5 part by weight to 15 parts by weight, a usage amount of the lubricant (D) is 0.05 part by weight to 1 part by weight, a usage amount of the antioxidant (E) is 0.1 part by weight to 1 part by weight.

A product of the invention is made by using the polyester composition above as an engineering plastic particle.

Based on the above, the polyester composition of the invention includes an inorganic powder (B). Thus, the polyester composition may have good physical properties and processability. In addition, the polyester composition of the invention may be processed as an engineering plastic particle, and may be processed at low mold temperatures to make the process simple and easy to implement, and thus, has industrial mass production value.

In order to make the features and advantages of the invention more obvious and understandable, examples are given below for detailed description.

### DESCRIPTION OF THE EMBODIMENTS

The following are examples that describe the content of the invention in detail. The implementation details provided in the embodiments are for illustrative purposes and are not intended to limit the scope of protection of the invention. Anyone with ordinary knowledge in the art may modify or change these implementation details according to the needs of the actual implementation. Additionally, descriptions of well-known devices, methods, and materials may be omitted so as not to obscure the various principles of the invention.

A range herein may be expressed as from “about” one specific value to “about” another specific value, and it may also be expressed directly as one specific value and/or to another specific value. In expressing ranges, another embodiment includes from the one particular value and/or to another particular value. Similarly, when a value is expressed as an approximation by use of the antecedent “about,” it will be understood that the particular value forms another embodiment. It will be further understood that the endpoints of each range are clearly related or independent of the other endpoints.

Herein, non-limiting terms (such as: may, can, for example or other similar terms) refer to unessential or optional implementation, inclusion, addition or existence.

Unless otherwise defined, all terms (including technical and scientific terms) used herein have the same meaning as commonly understood by those with ordinary knowledge in the art. It will also be understood that terms (such as those defined in commonly used dictionaries) shall be construed to have a meaning consistent with their meaning in the relevant technical context and shall not be construed in an idealized or overly formal sense, except expressly so defined herein.

### <Polyester Composition>

The invention provides a polyester composition, which includes polyethylene terephthalate (A), an inorganic powder (B), a crystal nucleating agent (C), a lubricant (D) and an antioxidant (E). In addition, the polyester composition of the invention may further include other polymer (F), a compatibilizer (G) or other suitable additives according to needs. Each of the above components will be described in detail as follows.

In this embodiment, the polyester composition may not include a glass fiber. Compared with currently known polyester composition including a glass fiber, the polyester composition which does not include a glass fiber in this embodiment has better fluidity and thus has good processability and may be suitable for performing processes. In addition, compared with currently known polyester composition including a glass fiber, the polyester composition which does not include a glass fiber in this embodiment may be applied to processing technologies (such as extrusion molding, injection molding or plate processing methods) under low temperature conditions (such as a mold temperature below 90° C.), so that there is no need for post-crystallization in subsequent processes, which may improve the production efficiency of the product and thereby reduce energy consumption.

### Polyethylene Terephthalate (A)

The polyethylene terephthalate (A) is not particularly limited, and suitable polyethylene terephthalate may be selected according to needs. For example, the polyethylene terephthalate (A) may include a virgin pellet, an environmentally friendly recycled pellet or other suitable polyethylene terephthalate. The sources of the environmentally friendly recycled pellet may include a bottle recycled pellet, a film material recycled pellet, a fabric recycled pellet, an industrial recycled environmentally friendly recycled polyester pellet (such as a release film, etc.) or other polyethylene terephthalate product to achieve the needs of importing recycled materials, but is not limited thereto.

In this embodiment, the intrinsic viscosity of the polyethylene terephthalate (A) is 0.7 dL/g to 1 dL/g, preferably 0.7 dL/g to 0.92 dL/g. The intrinsic viscosity of the environmentally friendly recycled pellet may be usually from 0.5 dL/g to 0.62 dL/g. Therefore, the environmentally friendly recycled pellet may firstly undergo a viscosity-increasing step to increase an intrinsic viscosity thereof, and then the environmentally friendly recycled pellet with increased intrinsic viscosity may be used in the polyester composition. When the intrinsic viscosity of the polyethylene terephthalate (A) is less than 0.7 dL/g, the polyethylene terephthalate (A) may have too low impact strength to let the product made thereof has a problem of strong inadequate and/or embrittlement. When the intrinsic viscosity of the polyethylene terephthalate (A) is greater than 1 dL/g, the viscosity of the polyethylene terephthalate (A) may be too high to make the polyester composition poor in fluidity and difficult to apply in performing processes.

Based on a total usage amount of the polyester composition being 100 parts by weight, a usage amount of the polyethylene terephthalate (A) is 30 parts by weight to 80 parts by weight, preferably 33 parts by weight to 70 parts by weight.

### Inorganic Powder (B)

The inorganic powder (B) is not particularly limited, and suitable inorganic powder may be selected according to needs. For example, the inorganic powder (B) may include a micro-nano-scale inorganic powder or other suitable inorganic powders. The particle size of the inorganic powder (B) may be 0.3 micron to 10 microns, preferably 0.7 micron to 5 microns. In this embodiment, the inorganic powder (B) may include talc powder, titanium dioxide, silicon dioxide, mica, calcium carbonate, calcium sulfate whisker or other suitable inorganic powders, preferably calcium carbonate, talc powder, silicon dioxide or a combination thereof.

Based on a total usage amount of the polyester composition being 100 parts by weight, a usage amount of the inorganic powder (B) is 5 parts by weight to 30 parts by weight, preferably 10 parts by weight to 25 parts by weight.

When the polyester composition includes an inorganic powder (B), the polyester composition may have better heat resistance, and have good mechanical properties and structural order at the same time. At the same time, when the usage amount of the inorganic powder (B) is less than 5 parts by weight, the effect of improving the crystallinity and heat resistance of the polyester composition may not be significant. When the usage amount of the inorganic powder (B) is greater than 30 parts by weight, the improvement of the crystallinity and heat resistance of the polyester composition may reach the limit.

### Crystal Nucleating Agent (C)

The crystal nucleating agent (C) is not particularly limited, and suitable crystal nucleating agent may be selected according to needs. In this embodiment, the crystal nucleating agent (C) may include an organic acid sodium salt or other suitable crystal nucleating agents. For example, the organic acid sodium salt may include sodium benzoate, sodium montanate, EMAA Surlyn resin (trade name, manufactured by DuPont) or other suitable organic acid sodium salts, preferably EMAA Surlyn resin, sodium benzoate or a combination thereof.

Based on a total usage amount of the polyester composition being 100 parts by weight, a usage amount of the crystal nucleating agent (C) is 0.5 part by weight to 15 parts by weight, preferably 3 parts by weight to 10 parts by weight.

### Lubricant (D)

The lubricant (D) is not particularly limited, and suitable lubricant may be selected according to needs. In this embodiment, the lubricant (D) may include a stearate, a polyethylene wax, a silicone modifier, a fluorine-based resin or other suitable lubricants, preferably a polyethylene wax, a stearate or a combination thereof.

Based on a total usage amount of the polyester composition being 100 parts by weight, a usage amount of the lubricant (D) is 0.05 part by weight to 1 part by weight, preferably 0.1 part by weight to 0.5 part by weight.

### Antioxidant (E)

The antioxidant (E) is not particularly limited, and suitable antioxidant may be selected according to needs. In this embodiment, the antioxidant (E) may include a hindered phenolic-based antioxidant, a phenolic-based antioxidant, a phosphite ester-based antioxidant, a complex antioxidant or other suitable antioxidants, preferably a phosphite ester-based antioxidant. For example, the phosphite ester-based antioxidant may include phosphite ester, tris(2,4-di-tert-butylphenyl)phosphite ester, Everaox® 201 (trade name, manufactured by Everlight Chemical Industry Co., Ltd.) or other suitable phosphite ester-based antioxidants.

Based on a total usage amount of the polyester composition being 100 parts by weight, a usage amount of the antioxidant (E) is 0.1 part by weight to 1 part by weight, preferably 0.1 part by weight to 0.5 part by weight.

### Other Polymer (F)

The other polymer (F) does not include the polyethylene terephthalate (A). In addition, the other polymer (F) is not particularly limited, and suitable other polymer may be selected according to needs. In this embodiment, the other polymer (F) includes polypropylene, nylon 6, nylon 66, nylon 12 or other suitable polymers, preferably polypropylene, nylon 6 or a combination thereof.

Based on a total usage amount of the polyester composition being 100 parts by weight, a usage amount of the other polymer (F) is 2.5 parts by weight to 35 parts by weight, preferably 10 parts by weight to 25 parts by weight.

### Compatibilizer (G)

The compatibilizer (G) is not particularly limited, and suitable compatibilizer may be selected according to needs. In this embodiment, the compatibilizer (G) may include ethylene-methyl acrylate-glycidyl methacrylate terpolymer, polyethylene octene grafted methacrylic acid glycidyl ester, styrene-ethylene/butylene-styrene copolymer, styrene-ethylene/butylene-styrene block copolymer grafted with maleic anhydride or other suitable compatibilizers.

Based on a total usage amount of the polyester composition being 100 parts by weight, a usage amount of the compatibilizer (G) is 5 parts by weight to 20 parts by weight, preferably 7 parts by weight to 13 parts by weight. When the usage amount of the compatibilizer (G) is greater than 20 parts by weight, the heat deflection temperature of the polyester composition may be reduced.

When the polyester composition includes the other polymer (F), the compatibilizer (G) may be added to improve the interfacial compatibility between the various components. In the case where the polyester composition further includes the other polymer (F), the compatibilizer (G) or other suitable additives, it is preferred to include a combination of the other polymer (F) and the compatibilizer (G). When the polyester composition includes the other polymer (F) and the compatibilizer (G), the polyester composition may have better heat resistance, and have good mechanical properties and structural order at the same time. For example, when the other polymer (F) is polypropylene, nylon 6 or a combination thereof, the compatibilizer (G) is preferably a styrene-ethylene/butylene-styrene copolymer.

### <Preparation Method of Polyester Composition>

The preparation method of the polyester composition is not particularly limited. For example, the polyethylene terephthalate (A), the inorganic powder (B), the crystal nucleating agent (C), the lubricant (D) and the antioxidant (E) are placed in a stirrer and stirred to be uniformly mixed into a solution state. If needed, the other polymer (F) and the compatibilizer (G) may also be added. After mixing uniformly, a liquid polyester composition is obtained.

### <Product>

An exemplary embodiment of the invention provides a product made by using the polyester composition as an engineering plastic particle.

For example, the polyester composition may be processed into a product as an engineering plastic pellet. The processing process is not particularly limited, and suitable processing method may be selected according to needs. The processing process may include extrusion molding, injection molding, sheet metal processing methods or other suitable processing methods.

The temperature of the mold during the processing process may be below 90° C., preferably 60° C. to 80° C. Thus, a product formed from the mold may be directly processed into subsequent steps without cooling down firstly, and thus improving the production efficiency of the product and reducing energy consumption.

Hereinafter, the invention will be described in detail with reference to examples. The following examples are provided to describe the invention, and the scope of the invention includes the scope described in the following claims and their substitutions and modifications, and is not limited to the scope of the examples.

### EXAMPLES

In order to prove that the polyester composition proposed by the invention has excellent mechanical properties and may further have good heat resistance, this experimental example is made below.

The component types and usage amounts of the polyester compositions of Example 1 to Example 3 and Comparative Example 1 are listed in Table 1 below. The prepared polyester composition was analyzed in the following test methods, and the results are shown in Table 1.

### Test Methods

Heat Deflection Temperature (HDT): Tested under a pressure of 0.45 MPa according to ASTM D648 standard. The obtained value is the ability of the polyester composition to resist thermal deformation. The higher the value, the higher the heat resistance of the polyester composition.

Tensile Strength: Tested according to ASTM D638 standard. The obtained value is the total energy that the polyester composition may withstand against tensile deformation. The higher the value, the higher the tensile strength the polyester composition may withstand.

Flexural Strength: Tested according to ASTM D790 standard. The obtained value is the ability of the polyester composition to resist bending deformation. The higher the value, the higher the flexural strength the polyester composition may withstand.

Impact Strength: Tested according to ASTM D256 standard. The obtained value (kg-cm/cm) is the total energy that the polyester composition may withstand when broken. The higher the value, the higher the impact strength (or the resistance strength of the polyester composition) that the polyester composition may withstand.

Crystallinity: Tested with differential scanning calorimetry (DSC). The obtained value is a ratio of the crystalline part of the polyester composition to the total amount of the polyester composition. The higher the value, the higher the degree of structural order of the polyester composition.

TABLE 1

| | | | | | Comparative |
|---|---|---|---|---|---|
| Component | | Examples | | | Examples |
| (unit: parts by weight) | | 1 | 2 | 3 | 1 |
| Polyethylene | PET | 64.5 | 34.5 | 34.5 | 89.5 |
| terephthalate (A) | (IV = 0.76 dL/g) | | | | |
| Inorganic powder | Calcium carbonate | 25 | 25 | 25 | — |
| (B) | | | | | |
| Crystal nucleating | Surlyn 8920 | 10 | 10 | 10 | 10 |
| agent (C) | | | | | |
| Lubricant (D) | Polyethylene wax | 0.2 | 0.2 | 0.2 | 0.2 |
| Antioxidant (E) | Phosphite ester | 0.3 | 0.3 | 0.3 | 0.3 |
| Other polymer (F) | Polypropylene | — | 20 | — | — |
| | Nylon 6 | — | — | 20 | — |
| Compatibilizer (G) | Styrene-ethylene/ | — | 10 | 10 | — |
| | butylene-styrene | | | | |
| | copolymer | | | | |
| Mechanical | Heat deflection | 108 | 127 | 185 | 78 |
| properties | temperature (° C.) | | | | |
| | Tensile strength (MPa) | 64.59 | 43.41 | 44.75 | 65.57 |
| | Flexural strength (MPa) | 101.26 | 72.28 | 96.16 | 96.22 |
| | Impact strength (kg-cm/cm) | 4.01 | 3.21 | 2.44 | 3.56 |
| | Crystallinity (%) | 41.39 | 40.31 | 50.7 | 18.68 |

*Surlyn 8920 is a trade name manufactured by DuPont.

As may be seen from Table 1 that the heat deflection temperature of Example 1 to Example 3 in which the polyester composition includes inorganic powder (B) is greater than or equal to 100° C., that is, they have good heat resistance, and have good mechanical properties and the degree of structural order at the same time, and thus, may be suitable for subsequent processing to make a product. On the other hand, the heat deflection temperature of Comparative Example 1 in which the polyester composition does not include the inorganic powder (B) is less than 100° C., and its heat resistance is poor.

In addition, compared to the polyester composition not including the other polymer (F) and the compatibilizer (G) (Example 1), the polyester composition including the other polymer (F) and the compatibilizer (G) (Examples 2 to 3) have higher heat deflection temperature, that is, better heat resistance. Therefore, when the polyester composition includes the other polymer (F) and the compatibilizer (G), the polyester composition may have better heat resistance, and good mechanical properties and the degree of structural order at the same time.

In addition, the polyester compositions of Example 1 to Example 3 of this embodiment which do not include a glass fiber have good heat resistance, mechanical properties and the degree of structural order, such that the polyester composition has good processability and is suitable for subsequently processed to make a product. On the other hand, the currently known polyester compositions containing a glass fiber have high hardness and high brittleness, which makes the polyester compositions have poor fluidity and are difficult to apply further process, that is, they have poor processability.

In addition, when the polyester composition of Example 1 to Example 3 of this embodiment does not include a glass fiber but includes an inorganic powder (B), it may be injection molded at a low mold temperature (for example, below 90° C.) when processed as an engineering plastic particle, and there is no need for subsequent post-crystallization, which improves the production efficiency of the product and thereby reduces energy loss. On the other hand, when currently known glass fiber-free polyester compositions are processed as an engineering plastic pellet, they need to be injection molded at a high mold temperature (for example, above 120° C.) or injection molded at a low mold temperature with post-crystallization. Both methods of making products from currently known glass fiber-free polyester compositions include a high-temperature crystallization process, which requires cooling down before carrying out the subsequent processes. The cooling step increases the number of process steps and time, thereby reducing the production efficiency of the product.

Based on the above, when the polyester composition of the invention includes an inorganic powder (B), the polyester composition has good heat resistance, mechanical properties and the degree of structural order, and thus, may be suitable for subsequent processing to make a product. In particular, a product may be molded (such as injection molding) at low mold temperatures (for example, below 90° C.), and may be applied to tableware, buckles, zippers and other products that require good heat resistance to achieve the purpose of single material.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A polyester composition, comprising:
a polyethylene terephthalate (A);
an inorganic powder (B);
a crystal nucleating agent (C);
a lubricant (D); and
an antioxidant (E).

2. The polyester composition according to claim 1, wherein the polyester composition does not contain a glass fiber.

3. The polyester composition according to claim 1, wherein the polyethylene terephthalate (A) has an intrinsic viscosity of 0.7 dL/g to 1 dL/g.

4. The polyester composition according to claim 1, wherein the inorganic powder (B) contains talc powder, titanium dioxide, silicon dioxide, mica, calcium carbonate, calcium sulfate whisker or a combination thereof.

5. The polyester composition according to claim 1, wherein the crystal nucleating agent (C) contains an organic acid sodium salt.

6. The polyester composition as claimed in claim 1, wherein the lubricant (D) contains a stearate, a polyethylene wax, a silicone modifier, a fluorine-based resin or a combination thereof.

7. The polyester composition according to claim 1, wherein the antioxidant (E) contains a hindered phenolic-based antioxidant, a phenolic-based antioxidant, a phosphite ester-based antioxidant, a complex antioxidant or a combination thereof.

8. The polyester composition according to claim 1, further comprising an other polymer (F), a compatibilizer (G) or a combination thereof,
wherein the other polymer (F) does not contain the polyethylene terephthalate (A).

9. The polyester composition according to claim 8, wherein the other polymer (F) contains polypropylene, nylon 6, nylon 66, nylon 12 or a combination thereof.

10. The polyester composition according to claim 8, the compatibilizer (G) contains ethylene-methyl acrylate-glycidyl methacrylate terpolymer, polyethylene octene grafted methacrylic acid glycidyl ester, styrene-ethylene/butylene-styrene copolymer, styrene-ethylene/butylene-styrene block copolymer grafted with maleic anhydride or a combination thereof.

11. The polyester composition according to claim 8, wherein based on a total usage amount of the polyester composition being 100 parts by weight, a usage amount of the other polymer (F) is 2.5 parts by weight to 35 parts by weight, a usage amount of the compatibilizer (G) is 5 parts by weight to 20 parts by weight.

12. The polyester composition according to claim 1, wherein based on a total usage amount of the polyester composition being 100 parts by weight, a usage amount of the polyethylene terephthalate (A) is 30 parts by weight to 80 parts by weight, a usage amount of the inorganic powder (B) is 5 parts by weight to 30 parts by weight, a usage amount of the crystal nucleating agent (C) is 0.5 part by weight to 15 parts by weight, a usage amount of the lubricant (D) is 0.05 part by weight to 1 part by weight, a usage amount of the antioxidant (E) is 0.1 part by weight to 1 part by weight.

13. A product made by using the polyester composition according to claim 1 as an engineering plastic pellet.
